(19) United States
(12) Patent Application Publication
(10) Pub. No.: US 2016/0097468 A1
(43) Pub. Date: Apr. 7, 2016

(54) APPARATUS FOR LAUNCH AND RECOVERY OF FLEXIBLE HOSE AND METHOD OF USE

(71) Applicant: IKM CLEANDRILL AS, Straume (NO)

(72) Inventor: Harald Hufthammer, Straume (NO)

(73) Assignee: IKM Cleandrill AS, Straume (NO)

(21) Appl. No.: 14/892,675

(22) PCT Filed: May 27, 2014
(86) PCT No.: PCT/GB2014/051606

§ 371 Date: Nov. 20, 2015

(30) Foreign Application Priority Data
May 24, 2013 (NO) 20130725

(51) Int. Cl. F16L 1/20; E21B 21/01; F16L 1/235

(52) U.S. Cl. CPC F16L 1/207; F16L 1/235; E21B 21/01

(57) ABSTRACT

An apparatus (130) for the deployment of a flexible hose having a hose coupling from an offshore platform or vessel. The apparatus comprises a support frame (134) and a rotating assembly (132) mounted on the support frame on a main rotation axis. The rotating assembly has a plurality of hose guide surfaces (142) arranged to contact a flexible hose and enable relative movement of the flexible hose with respect to the rotating assembly. The rotating assembly comprises at least one radial recess (139) disposed between a pair of adjacent hose guide surfaces, and which is configured to accommodate a hose coupling. Methods of use in riserless offshore drilling operations are described.

The present invention relates to an apparatus and method for hose deployment, and in particular to an apparatus for launch and recovery of a flexible hose from an offshore vessel or structure to a subsea location, and a method of use.

### BACKGROUND TO THE INVENTION

The background to the invention and its preferred embodiments will be described in relation to offshore and marine operations, although it will be appreciated that the invention also has application to freshwater systems such as lakes and rivers.

In offshore and marine industries such as the hydrocarbon exploration and production industry, it is often necessary to use a hose to transport fluids and/or solids between a vessel or structure at surface and a seabed location. In this context, the hose is a flexible, collapsible conduit defining a bore through which fluids or solids may be conveyed. Transport of the material may be upwards (i.e. from the seabed to the surface structure) or downwards (i.e. from the surface structure to the seabed) depending on the particular operation.

Many hoses used in such applications are required to be deployed significant distances. It is generally desirable to use a flexible, collapsible hose in order to reduce the cost of the hose and reduce its size while stored on a hose storage reel. Flexible hoses used in these applications are formed in hose sections joined to one another by hose connections which are swaged onto the hose material. Such hoses have significant weight, particularly when combined with a weight of the material being transported inside the hose, and this weight may be too great to be supported by the inherent longitudinal strength of the hose. In these situations, it is known to support the hose with a load-bearing element. The load-bearing element may be a nearby structural member, for example a platform leg or riser pipe, with the hose attached to the load-bearing elements at regular intervals on the hose. An alternative approach is to deploy a load-bearing element in the form of the support wire or umbilical alongside the hose, and secure the support wire to the hose at regular intervals. The support wire may be a dedicated support wire stored on and deployed from a rail, or alternatively may be a crane wire which forms part of the standard vessel and rig deck equipment. Alternatively, an umbilical (which is a wire-sheathed, bundled cable having additional functionality such as supplying power and control conduits for subsea equipment) may be used. Whatever the nature of the load-bearing element, it may be tied to the hose by means of bolted clamps, clips, chain or wire straps, rope or webbing straps.

The applicant's co-pending International Patent Publication Number WO 2012/140447 relates to an apparatus and method for deployment and retrieval of the hose from an offshore structure or vessel. The apparatus comprises a mechanism which couples a flexible hose and a flexible load-bearing element together to form a supported hose assembly as the hose and the load-bearing elements are fed to the apparatus.

In systems such as that described in WO 2012/140447, it is necessary for the hose to include attachment points at intervals along its length. These attachment surfaces need to be brought into close proximity with the load-bearing element so that the hose and the load-bearing element may be safely and conveniently coupled to one another.

WO 2011/089479 describes a support structure for a subsea cable or similar element which comprises a plurality of sheaves on an assembly, and a locking mechanism which prevents rotation of the assembly during deployment of the cable. The locking mechanism is released to allow an integrated element to pass the support structure.

U.S. Pat. No. 5,906,235 describes a winch for a cable, the winch comprising an assembly of drums, The assembly is driven to rotate to enable a lump in the cable to pass around the winch.

### SUMMARY OF INVENTION

It is amongst the aims and objects of the invention to provide an apparatus for the deployment of a hose and a method of use which is improved with respect to previously proposed apparatus and methods.

It is amongst the aims and objects of the invention to provide an apparatus suitable for the deployment and recovery of a flexible hose which comprises hose couplings along its length and a method of use.

Another aim of the invention is to provide an apparatus suitable for the deployment and recovery of a flexible hose which is configured to be coupled to a load-bearing element and a method of use.

Other aims and objects of the invention will become apparent from the following description.

According to the first aspect of the invention, there is provided an apparatus for the deployment and recovery of a flexible hose having a hose coupling, the apparatus comprising:
a support frame;
a rotating assembly mounted on the support frame on a main rotation axis;
wherein the rotating assembly comprises a plurality of hose guide surfaces arranged to contact a flexible hose and enable relative movement of the flexible hose with respect to the rotating assembly;
and wherein the rotating assembly comprises at least one radial recess disposed between a pair of adjacent hose guide surfaces, the at least one radial recess configured to accommodate a hose coupling.

The rotating assembly may comprise a plurality of arms extending radially from the main rotation axis. The rotating assembly preferably comprises three arms, but may comprise four or more arms.

Preferably the hose guide surfaces define an outer radius of the rotating assembly.

The rotating assembly may comprise a plurality of roller assemblies, and the roller assemblies may comprise the hose guide surfaces.

The hose guide surfaces may be located at distal ends of the arms.

Preferably, the rotating assembly is free to rotate on the main rotation axis.

The roller assemblies may be free to rotate on respective roller axes.

The apparatus may be configured to receive a flexible hose from a hose storage reel, and guide the flexible hose to a coupling location. The apparatus may be configured to guide the hose to a coupling orientation, which may be a vertical coupling orientation.

The apparatus may comprise one or more lateral guides, configured to guide the hose to the hose guide surfaces of the rotating assembly. The lateral guides may comprise one or more vertical-axis rollers.

The recess may be configured to accommodate an inflexible, stiff or rigid hose coupling, which may comprise a substantially circular cross section, and/or may comprise a fixed outer diameter.

The hose coupling may be a connection between adjacent hose sections assembled together to form the hose. Alternatively, or in addition, the hose coupling may be a part of the hose configured to support the weight of the hose, for example by providing an attachment point for a load-bearing element such as a cable or umbilical.

Preferably, the recess is configured to accommodate a hose coupling having an outer diameter of approximately 150 mm to 250 mm, and more preferably is configured to accommodate a hose coupling having an outer diameter of approximately 180 mm to 205 mm.

Preferably, the recess is configured to accommodate a hose coupling comprising a length greater than 300 mm. Preferably, the recess is configured to accommodate a hose coupling comprising a length of approximately 300 mm to 600 mm, and preferably comprises a length of approximately 450 mm and 500 mm.

The apparatus may comprise a stop mechanism for retaining a hose section with respect to the apparatus.

According to a second aspect of the invention there is provided a system for deployment and recovery of a hose from an offshore structure or vessel, the system comprising a flexible hose comprising a hose coupling and the roller apparatus according to the first aspect of the invention.

The hose coupling may be an inflexible, stiff or rigid hose coupling, which may comprise a substantially circular cross section, and/or may comprise a fixed outer diameter.

The hose coupling may be a connection between adjacent hose sections assembled together to form the hose. Alternatively, or in addition, the hose coupling may be a part of the hose configured to support the weight of the hose, for example by providing an attachment point for a load-bearing element such as a cable or umbilical.

Preferably, the hose coupling has an outer diameter of approximately 150 mm to 250 mm, and more preferably has an outer diameter of approximately 180 mm to 205 mm.

The hose coupling may comprise a length greater than 300 mm. The hose coupling may comprise a length of approximately 300 mm to 600 mm, and preferably comprises a length of approximately 450 mm and 500 mm.

The hose coupling preferably comprises a coupling surface for attaching a load-bearing element to the hose. The load-bearing may comprise a cable or an umbilical.

Preferably the hose is a drilling fluid and/or solid return line from a subsea drilling operation.

Embodiments of the second aspect of the invention may include one or more features of the first aspect of the invention or its embodiments, or vice versa.

According to a third aspect of the invention there is provided a riserless mud return system for an offshore drilling operation, the system comprising the hose deployment and recovery system of the second aspect of the invention.

Embodiments of the third aspect of the invention may include one or more features of the first or second aspects of the invention or their embodiments, or vice versa.

According to a fourth aspect of the invention, there is provided a method of deploying a hose from an offshore structure or vessel, the method comprising:
providing an apparatus comprising a rotating assembly mounted on the support frame on a main rotation axis and having a plurality of hose guide surfaces;
deploying a flexible hose having hose coupling from a hose storage reel;
passing the flexible hose over the hose guide surfaces and the rotating assembly;
accommodating a hose coupling in a radial recess disposed between a pair of adjacent hose guide surfaces and passing the hose coupling over the rotating assembly.

Passing the hose coupling over the rotating assembly may comprise rotating the rotating assembly with respect to the main rotation axis.

The method may comprise orienting the rotating assembly to accommodate the hose coupling.

Passing the flexible hose over the hose guide surfaces may comprise rotating one or more roller assemblies of the roller apparatus.

The method may comprise freely rotating the rotating assembly on the main rotation axis, and/or may comprise freely rotating the roller assemblies on respective roller axes.

The method may comprise guiding the flexible hose to a coupling location, and/or may comprise guiding the flexible hose to a coupling orientation. The coupling orientation may be a vertical coupling orientation.

The method may comprise coupling the hose to a load-bearing element, which may comprise a cable or an umbilical.

Embodiments of the fourth aspect of the invention may include one or more features of the first to third aspects of the invention or their embodiments, or vice versa.

According to a fifth aspect of the invention, there is provided a method of recovering a hose to an offshore structure or vessel, the method comprising:
providing an apparatus comprising a rotating assembly mounted on the support frame on a main rotation axis and having a plurality of hose guide surfaces;
recovering a flexible hose having hose coupling from a subsea location;
passing the flexible hose over the hose guide surfaces and the rotating assembly;
accommodating a hose coupling in a radial recess disposed between a pair of adjacent hose guide surfaces and passing the hose coupling over the rotating assembly.

The method may comprise guiding the flexible hose from a decoupling orientation and decoupling the hose from a load-bearing element. The decoupling orientation may be a vertical orientation.

Embodiments of the fifth aspect of the invention may include one or more features of the first to fourth aspects of the invention or their embodiments, or vice versa.

### BRIEF DESCRIPTION OF THE DRAWINGS

There will now be described, by way of example only, various embodiments of the invention with reference to the drawings, of which:

FIGS. 1A to 10 show a hose deployment system according to an embodiment of the invention, shown during sequential stages of deployment to a subsea location;

FIG. 2 is a side view of a roller apparatus according to an embodiment of the invention and used in the hose deployment system of FIGS. 1A to 10;

FIGS. 3A to 3D show successive stages of deployment of a flexible hose including the passing of a hose coupling over the roller apparatus of FIG. 2; and

FIGS. 4A to 4D show successive stages of connection of flexible hose sections.

### DETAILED DESCRIPTION OF THE PREFERRED EMBODIMENTS

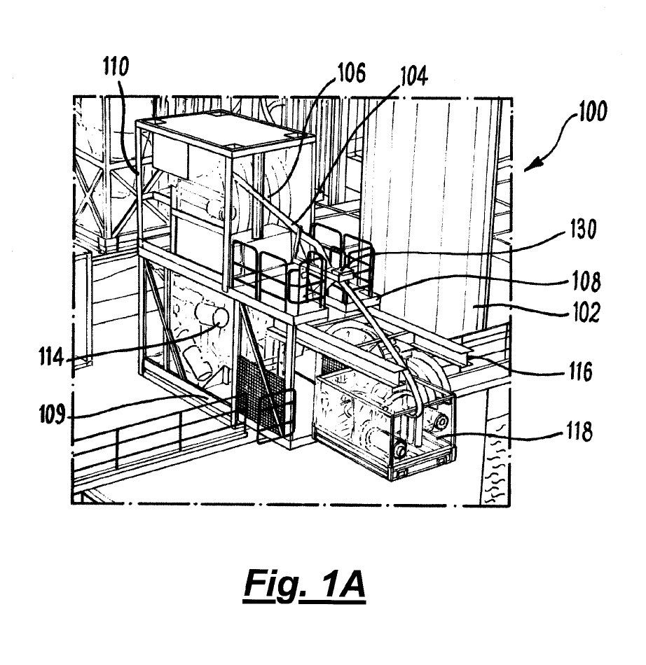

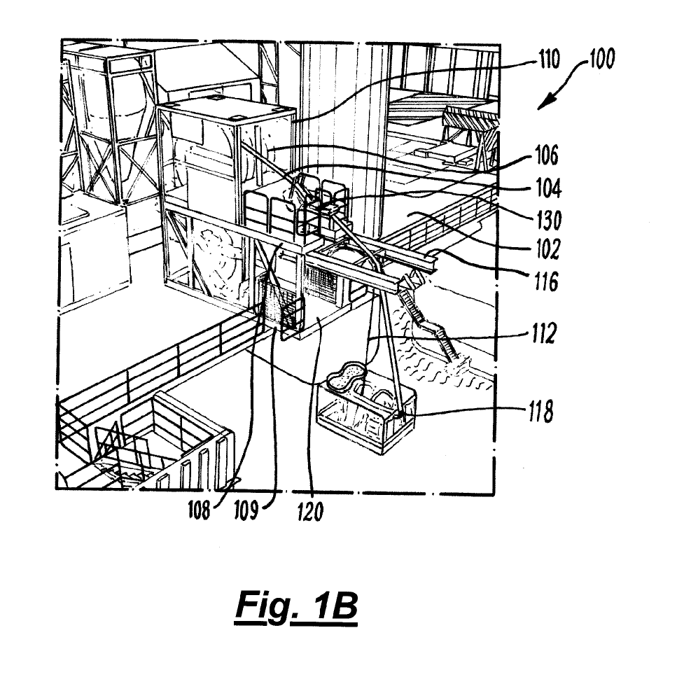

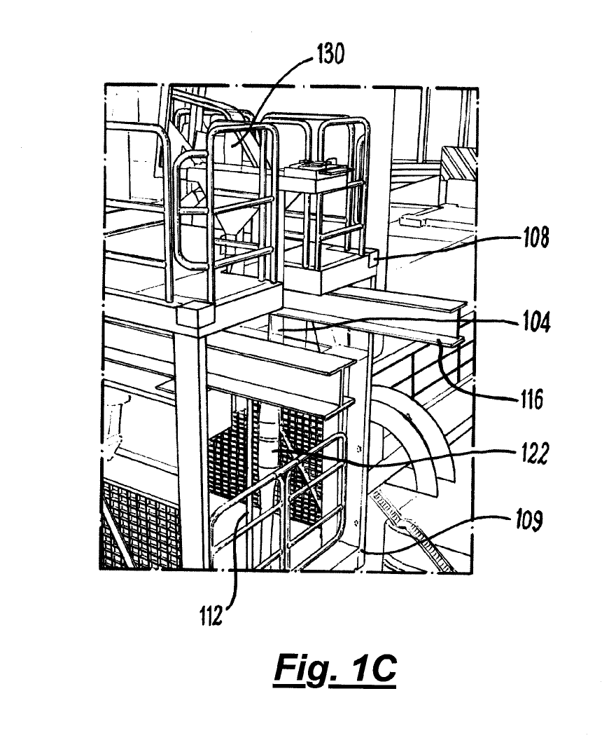

Referring firstly to FIGS. 1A to 10 and FIG. 2, there is shown schematically a hose deployment system 100 according to an embodiment of the invention, incorporating a roller apparatus 110. The system 100 is shown on an offshore drilling rig 102. The system comprises a flexible hose 104 deployed from a hose storage reel 106, arranged to rotate about a horizontal axis on an upper support platform 108 of a frame 110. A lower support platform 109 of the frame accommodates an umbilical 112 on an umbilical storage reel 114.

The umbilical 112 and the hose 104 are connected to a skid 118 which supports subsea equipment such as pumps, manifolds and subsea control equipment.

The frame also comprises an extendable cantilever structure 116 which provides a guide for the hose 104 and the umbilical 112 during an initial launch of a subsea skid 118. The cantilever structure 116 provides sufficient clearance for the skid to be laterally displaced from the side of the frame and the offshore drilling platform 102 during launch. When the skid 118 is lowered to the point at which it is clear of the side of the offshore platform, the cantilever 116 can be retracted such that the hose 104 and the umbilical extend substantially vertically between the upper support platform 108 and the lower support platform 109, through an aperture 120 provided in the lower support platform. As most clearly shown in FIG. 10, the hose 104 and the umbilical 112 extend vertically in close proximity to one another, to enable the hose to be clamped or otherwise attached to the umbilical from the lower support platform 109. This enables the umbilical to support the load of the hose during deployment, during operations, and during retrieval of the hose and subsea equipment.

The hose 104 is a flexible, collapsible hose, which is selected to be relatively low in cost and be compact when stored on a storage reel. The hose 104 is made of a number of continuous hose sections, joined together by hose couplings 122, which are in the form of rigid or stiff sub-assemblies located at respective ends of adjacent hose sections. The hose couplings are stiff and straight and of fixed outer diameter, and are swaged onto the hose section to provide connection points between hose sections. The hose 104 is also required to provide engageable surfaces for attachment of the umbilical 112 (or another load-bearing element). These engageable surfaces are conveniently provided on the hose couplings 122 of the flexible hose.

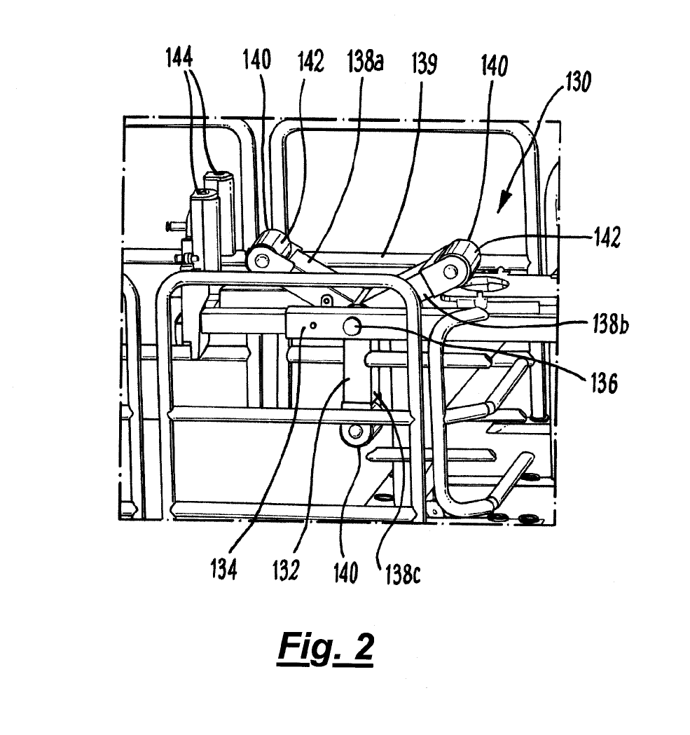

The system 100 includes a roller apparatus 130, shown most clearly in FIG. 2, which functions to guide the hose 104 to the correct vertical position for coupling to a load-bearing element and enable it to be deployed over the side of the offshore drilling platform. The roller apparatus 130 comprises a rotating assembly 132 mounted on a roller support frame 134. The rotating assembly 132 is free to rotate about a primary axis of rotation 136, which extends horizontally through the support frame 134. The rotating assembly 132 comprises three arms 138a, 138b and 138c, which extend radially outwards from the primary axis of rotation 136. Each arm 138 comprises a guide roller assembly 140, which defines a guide surface 142 for the hose 104 during deployment and retrieval. The roller assemblies 140 freely rotate around respective horizontal axes at the distal end of each arm 138.

The angular spacing between the arms 138 and the length of the arms determines a space 139 between an adjacent pair of guide surfaces 142. The spacing is selected to accommodate an inflexible or rigid hose coupling 122 of the hose as will be described below. The roller apparatus 130 also comprises a pair of vertical axis roller guides 144 which laterally guide the hose 104 to the roller apparatus.

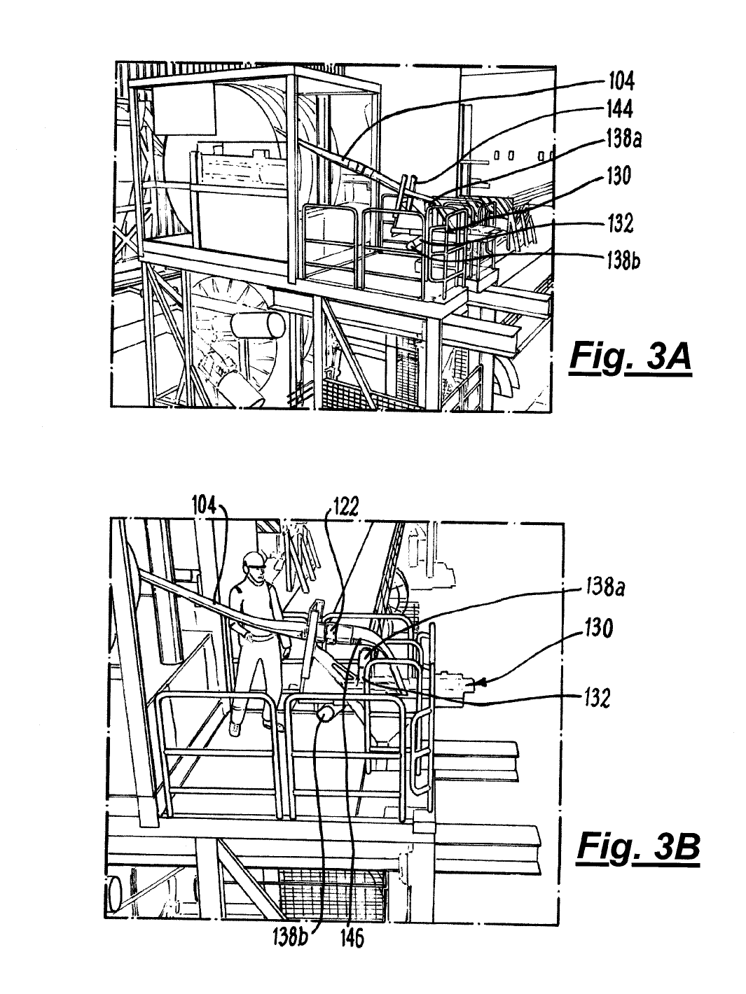

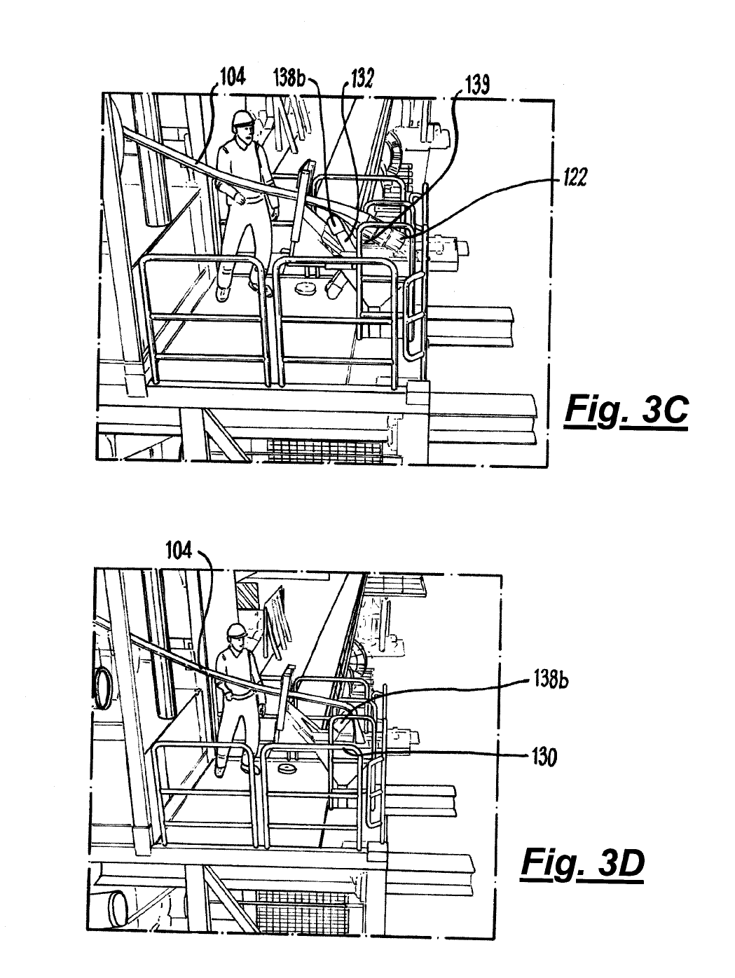

The function of the roller apparatus 130 in a hose deployment operation will now be described with reference to FIGS. 3A to 3D. In FIG. 3A, the flexible hose 104 is shown passing through vertical roller guides 144 as it is paid out from the hose reel 106. The hose is vertically flattened as it is deployed from the reel 106, and as it passes over the roller apparatus 130, it is guided by the guide surfaces 142 of the roller assemblies 140. The surface of the flexible hose 104 rolls over the individual roller assemblies 140 without the rotating assembly 130 being required to rotate about the primary axis 136.

FIG. 3B shows a hose coupling 122 of the hose 104 approaching the roller apparatus 130. The coupling 122 defines a fixed outer diameter that is larger than the collapsible main hose, which flattens against the roller guide surfaces 142. In this example, the hose coupling has an outer diameter of approximately 180 mm to 205 mm, and a length of approximately 450 mm to 500 mm, although hose couplings of other dimensions may be accommodated in alternative embodiments of the invention. When the hose coupling 122 approaches the roller 130, the freely rotating assembly 132 rotates in a clockwise or anti-clockwise direction to position itself around the hose coupling, so that the coupling is located in the space 139 between adjacent guide surfaces.

As the hose coupling 122 approaches the first arm 138a of the roller, a rounded shoulder 146 defined by a leading end of the coupling 122 does not easily pass over the roller guide surface 142. Instead, continued deployment of the hose 104 imparts a rotating force on the rotating assembly 132 against the guide roller, as shown in FIG. 3C. As the hose passes through the roller apparatus, the hose coupling is accommodated in the space 139 between an adjacent pair of roller guides until, in the position shown in FIG. 3D, the hose coupling is released from the roller apparatus 130 and passes substantially vertically from the upper support platform 108. As the hose is further deployed, it passes over the guide surfaces 142 defined by the roller assemblies 140 until the next coupling 122 arrives at the roller apparatus.

The roller apparatus 130 is an effective way of guiding the hose 104 to or from a position in which it can be coupled to or decoupled from a load-bearing element such as a cable or umbilical. It offers a number of advantages over a sheave-type guide, such as those used with coiled tubing or flexible conveyance equipment such as wirelines. In order to accommodate the hose couplings, a conventional sheave would require a large radius so that the circumferential curvature is able to take the stiff hose couplings 122 without causing lifting of the hose from the guide surface and/or bending of the hose during deployment or retrieval. In an offshore environment, such a large radius sheave would have a significant vertical height, footprint and mass, and would take up too much space on the platform to be practical for the envisaged applications.

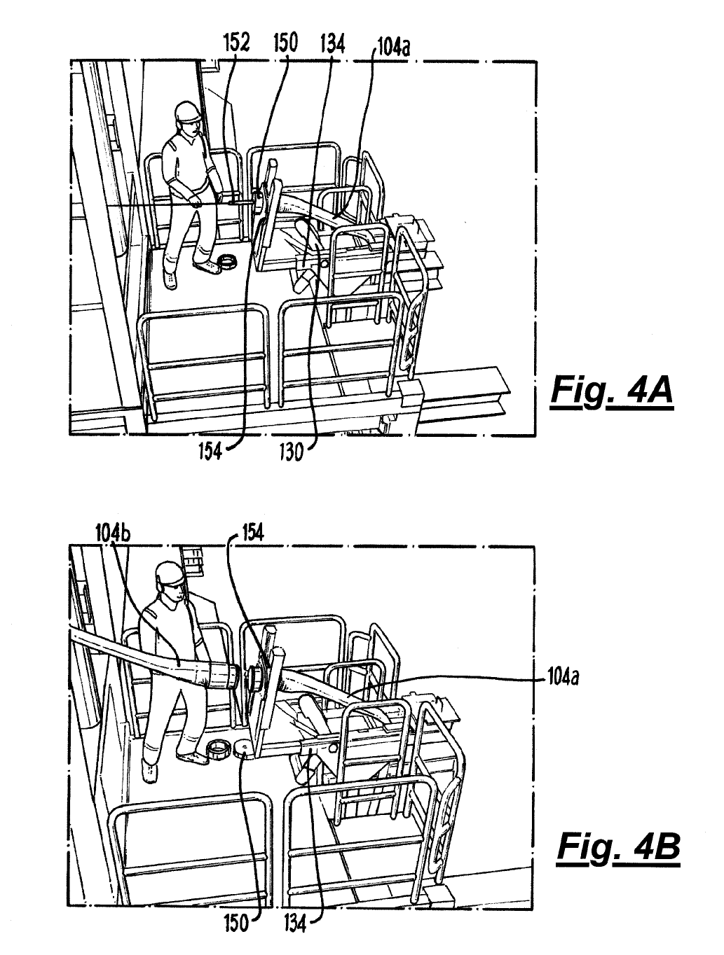

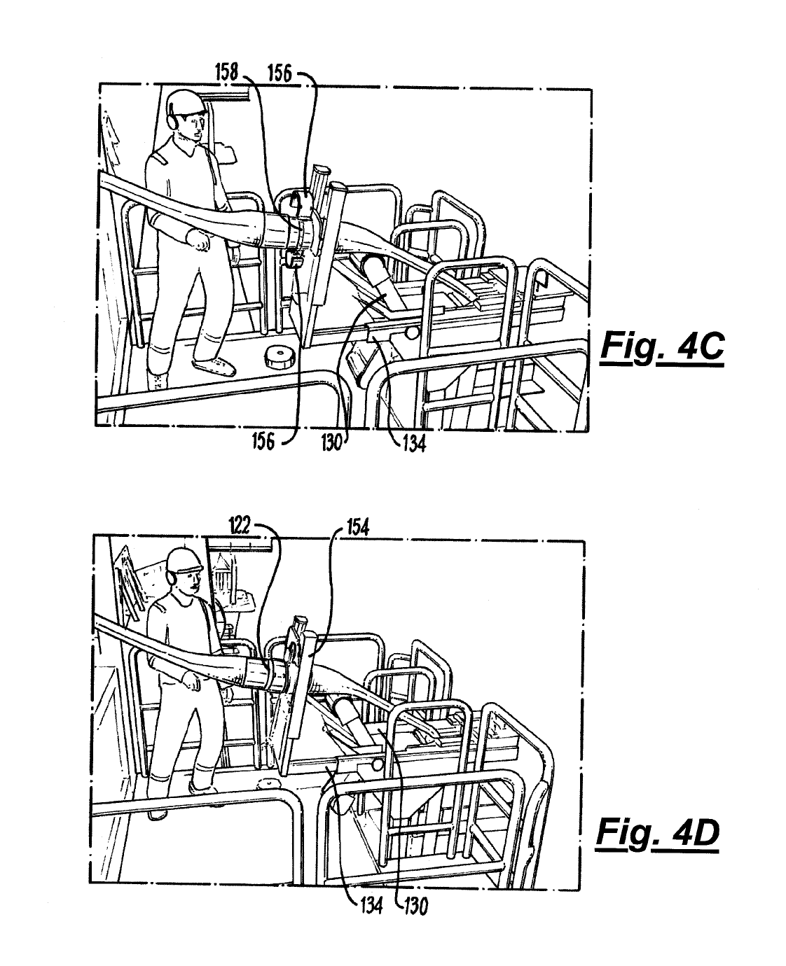

FIGS. 4A to 4D show sequential stages of the use of the support frame 134 of the roller apparatus 130, during the connection of adjacent hose sections. In FIG. 4A, a first hose section 104a has been guided through the roller assembly 130, and is terminated by a hose blind cap 150. The hose blind cap 150 is secured to a support line 152 which enables the hose section to be supported from the hose reel beyond a point at which is fully deployed from the reel. When the hose blind cap reaches the roller, a stop gate assembly 154 is closed to prevent further passage of the first hose section 104a. The blind cap 150 is removed and the support line 152 is detached.

As shown in FIG. 4B, a second hose section 104b is deployed from a second hose storage reel (not shown). The second hose section 104b is aligned with the first hose section 104a, which is held in place by the stop gate assembly 154.

As shown in FIG. 4C, upper and lower clamping members 156 are located over protruding flanges 158 of respective coupling sections of the first and second hose assemblies. A recess (not shown) in the clamping members 156 accommodates the flanges 158 to form a coupling 122 which joins hose sections 104a, 104b.

As shown in FIG. 4D, the stop gate assembly 154 is opened to enable the coupling 122 to pass through the vertical roller guides 144, and over the roller apparatus 130 as described with reference to FIGS. 3A to 3D.

The invention provides a roller apparatus for the deployment of a flexible hose having a hose coupling from an offshore platform or vessel. The roller apparatus comprises a support frame and a rotating assembly mounted on the support frame on a main rotation axis. The rotating assembly has a plurality of hose guide surfaces arranged to contact a flexible hose and enable relative movement of the flexible hose with respect to the rotating assembly. The rotating assembly comprises at least one radial recess disposed between a pair of adjacent hose guide surfaces, and which is configured to accommodate a hose coupling. Methods of use in riserless offshore drilling operations are described.

Various modifications to the above-described embodiments may be made within the scope of the invention, and the invention extends to combinations of features other than those expressly claimed herein.

1. An apparatus for the deployment and recovery of a flexible hose having a hose coupling, the apparatus comprising:
a support frame;
a rotating assembly mounted on the support frame on a main rotation axis;
wherein the rotating assembly comprises a plurality of hose guide surfaces arranged to contact a flexible hose and enable relative movement of the flexible hose with respect to the rotating assembly;
and wherein the rotating assembly comprises at least one radial recess disposed between a pair of adjacent hose guide surfaces, the at least one radial recess configured to accommodate a hose coupling;
and wherein the rotating assembly is configured to freely rotate about its main rotation axis to position itself around the hose coupling in use.

2. The apparatus according to claim 1, wherein the rotating assembly comprises a plurality of arms extending radially from the main rotation axis.

3. The apparatus according to claim 1, wherein the rotating assembly comprises a plurality of roller assemblies, and the roller assemblies comprise the hose guide surfaces.

4. The apparatus according to claim 3, wherein the rotating assembly and the roller assemblies are free to rotate on their respective axes.

5. The apparatus according to claim 1, configured to guide the hose to a vertical coupling orientation.

6. The apparatus according to claim 1, wherein the recess is configured to accommodate an inflexible, stiff or rigid hose coupling.

7. A system for deployment and recovery of a hose from an offshore structure or vessel, the system comprising a flexible hose comprising a hose coupling and the apparatus according to claim 1.

8. A riserless mud return system for an offshore drilling operation, the system comprising the hose deployment and recovery system according to claim 7.

9. A method of deploying a hose from an offshore structure or vessel, the method comprising:
providing an apparatus comprising a rotating assembly mounted on the support frame on a main rotation axis and having a plurality of hose guide surfaces;
deploying a flexible hose having hose coupling from a hose storage reel;
passing the flexible hose over the hose guide surfaces and the rotating assembly;
accommodating a hose coupling in a radial recess disposed between a pair of adjacent hose guide surfaces and passing the hose coupling over the rotating assembly;
wherein the rotating assembly freely rotates about its main rotation axis to position itself around the hose coupling.

10. A method of recovering a hose to an offshore structure or vessel, the method comprising:
providing an apparatus comprising a rotating assembly mounted on the support frame on a main rotation axis and having a plurality of hose guide surfaces;
recovering a flexible hose having hose coupling from a subsea location;
passing the flexible hose over the hose guide surfaces and the rotating assembly;
accommodating a hose coupling in a radial recess disposed between a pair of adjacent hose guide surfaces and passing the hose coupling over the rotating assembly;
wherein the rotating assembly freely rotates about its main rotation axis to position itself around the hose coupling.
